(19) United States
(12) Patent Application Publication
(10) Pub. No.: US 2026/0029964 A1
(43) Pub. Date: Jan. 29, 2026

(54) HARDWARE TRAFFIC GENERATOR USING LINEAR FEEDBACK SHIFT REGISTERS FOR TESTING OF MEMORY SUBSYSTEMS

(71) Applicant: Intel Corporation, Santa Clara, CA (US)

(72) Inventors: Sreenivas MANDAVA, Los Altos, CA (US); Jing LING, Milpitas, CA (US); Saurabh KOLAMBKAR, Santa Clara, CA (US); Jeffrey C. SWANSON, Sunnyvale, CA (US); Sharanya DIVAKARUNI, Danville, CA (US); Narasimha Sridhar SRIRANGAM, Portland, OR (US); Aishwarya RAJEN, San Jose, CA (US)

(21) Appl. No.: 19/347,743

(22) Filed: Oct. 2, 2025

Related U.S. Application Data
(60) Provisional application No. 63/818,759, filed on Jun. 6, 2025.

(51) Int. Cl. G06F 3/06

(52) U.S. Cl. CPC G06F 3/0659; G06F 3/0604; G06F 3/0673

(57) ABSTRACT

A device includes an injection determiner that includes a linear-feedback shift register (LFSR), configured to generate an LFSR-output for control of a probability of sending a read command or a write command; wherein the injection determiner is configured to compare the LFSR-output to a range of prospective LFSR-outputs; send a command to read from a memory or a command to write to a memory if the LFSR-output is within the range, and send no command to read from the memory and no command to write to the memory if the LFSR-output is outside of the range.

### CROSS-REFERENCE TO RELATED APPLICATIONS

This is a non-provisional patent application that claims priority to U.S. provisional patent application 63/818,759, filed on Jun. 6, 2025, the entire contents of which are incorporated herein by reference.

### BACKGROUND

Increasing core count and dynamic random-access memory (DRAM) frequency have resulted in a rapid scaling of memory channel count and per-channel bandwidth. A thorough, functional, electrical and function validation of memory subsystems including controllers, the physical layer interface (Phy) between the memory controller and the DRAM, and DRAM itself, requires validation devices to drive a high bandwidth to the memory while simulating real world workloads and traffic patterns. However, such driving of full bandwidth across all channels for the memory subsystem and DIMM validation typically requires many active cores and a fabric healthy enough to drive the full bandwidth within the appropriate power constraint. Additionally, disaggregating the memory die from the compute die necessitates solutions to validate standalone memory dies under high bandwidth conditions.

For a Systems on Chip (SOC) with multiple compute and input/output (IO) dies, it can take a very long time after silicon power-on to yield sufficiently healthy parts that can drive full memory bandwidth across all channels. This delays post-silicon validation of the memory subsystem and related platform features, often increasing the duration of the post-silicon validation cycle and risking product release schedules.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts a traffic generator;

FIG. 2 depicts a device according to an embodiment; and

FIG. 3 depicts a method of traffic generation.

### DETAILED DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, central processing unit (CPU), graphics processing unit (GPU), digital signal processor (DSP), field programmable gate array (FPGA), integrated circuit, application specific integrated circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

A low-cost, tunable hardware engine may be used to achieve electrical, functional, and Power and Performance (PnP) validation of a memory subsystem. This hardware engine may use Linear Feedback Shift Registers (LFSRs) as low-cost hardware that can generate pseudo-random sequences that may mimic various traffic patterns. It may drive full memory bandwidth independent of the SOC with traffic that replicates multiple workload and operating system (OS) behavior. Additionally, it may provide a path to reducing the cost of central processing unit (CPU) samples for use in DRAM by enabling low-yielding core count parts to be capable of completing dual in-line memory module (DIMM) testing.

As used herein, the term physical layer interface (PHY) refers to the physical circuitry that couples a memory controller to a memory device, such as a double data rate (DDR) dynamic random access memory (DRAM). The PHY implements the electrical signaling, timing, serialization/deserialization, and other physical interface functions necessary for communication between the logical memory controller and the external memory devices.

Although the principles and methods disclosed herein generally describe a use case of a specific memory controller, the underlying device can be used to generate traffic to other system agents, if desired, which may be in addition to, or as an alternative to, generating traffic for a memory controller. Such other devices may include, but are not limited to, any of Peripheral Component Interconnect Express (PCIE) controllers, fabric bridges, or Die-to-Die controllers.

Although various solutions for memory testing exist, such memory test engines may be suboptimal due to the fact that they do not replicate many real-world workload traffic conditions. They may mainly be used for electrical validation of the DDR link and cannot be exercised with many functional or performance features of the memory subsystem, whereas the principles and methods disclosed herein work seamlessly with the electrical, functional and performance features of memory controller and the physical layer interface (PHY). These engines may also rely on in-order scheduling of writing procedures (e.g., “writes”) and reading procedures (e.g., “reads”) in its implementation, which may severely constrain the richness of traffic patterns and performance of the memory controller. The principles and methods disclosed herein inject a pre-scheduler that is able to replicate bandwidth and traffic that match real workload workloads.

Various DRAM, data buffers, registered clock drivers (RCDs) and memory subsystem testing implementations have an LFSR, but these are typically used to generate pseudo-random data between the SOC's memory subsystem and the memory. Instead, it is desired to use LFSRs to create real application-like read and write traffic to the memory and not just to manipulate memory data.

The memory traffic generator creates DRAM traffic that is sent to the memory controller at varying bandwidths, without relying on other internet protocol agents such as the fabric, a device-to-device (D2D) interface, or cores. The memory traffic generator uses LFSRs as a low-cost hardware to support various traffic patterns by generating pseudo-random sequences. These sequences can be used to control different aspects of memory traffic such as, for example, data patterns, read and write traffic mixes, DRAM page hits, and bandwidth.

The principles and methods disclosed herein provide an efficient and flexible solution for memory traffic simulation to test and tune CPU memory sub-systems on silicon for electrical, functional and performance validation. Of note, this may be done with LFSRs in a manner that allows the chip to simulate realistic memory traffic scenarios with very inexpensive hardware in the SOC memory controller. This low-cost hardware allows each instance of the memory controller on the SOC to have this capability. Thus, each memory controller can simultaneously exercise full bandwidth to the attached DIMM. It can also be used by DRAM vendors as a DIMM testing and screening tool by exercising the full bandwidth on all memory channels, even when other components on the SOC are unable to drive that bandwidth.

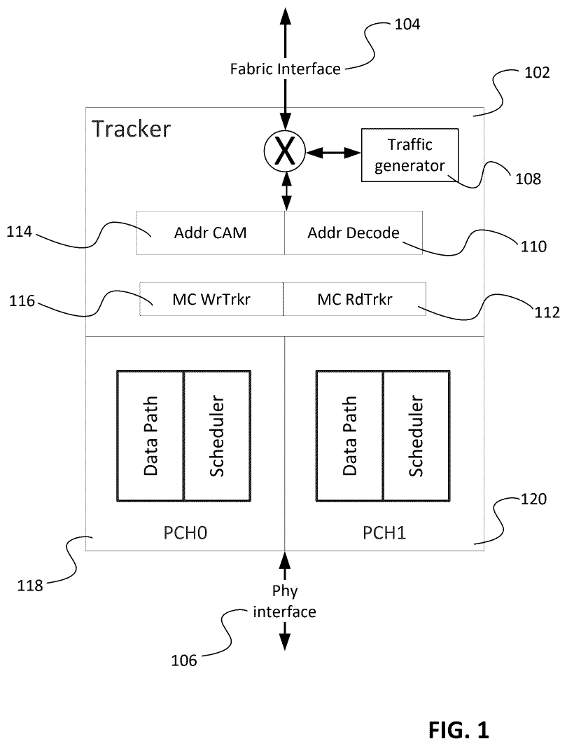

FIG. 1 depicts a traffic generator 102 in which the traffic generator is implemented as part of the memory controller. In this configuration, the traffic generator 102 is connected between the device fabric (e.g., via the fabric interface 104) and the PHY (e.g., via the PHY interface 106). The traffic generator 108 includes a plurality of LFSRs that are configured as disclosed here to generate simulated memory traffic. The traffic generator 102 may further include an address content-addressable memory (Addr CAM 114), which may describe a type of memory that, instead of retrieving data by address, can search for data by its content and returns the address or addresses where that data is found. This may, for example, refer to a content addressable memory (CAM) structure that stores address information or is used to efficiently look up or compare memory addresses. The traffic generator 102 may further include an address decoder 110 which may be or include a circuitry that translates a binary address (e.g., such as an address on an address bus) into a specific selection signal for a memory cell, memory module, or device within a computer system. The traffic generator 102 may further include an memory controller write tracker 116, which may describe a circuit, such as within the memory controller, that tracks write operations, their status, or their progress, such as by monitoring the write commands that have been issued, which are in progress, and/or which have completed. It may be useful in validation and debugging, such as by validating memory operations, detecting errors, and providing data for performance analysis. It may be used in integration, such as for complex memory subsystems where multiple write operations may be in flight at the same time. The traffic generator 102 may further include a memory controller read tracker 112, which may describe a circuit, which may be within the memory controller that may monitor and manage read operations. It may be configured to keep a record of which read commands have been issued, which are in progress, and which have completed; manage the flow of read operation, such as by ensuring that data is returned in the correct order and that no requests are lost or mishandled; and may provide visibility into the status of read operations for debugging, performance analysis, and validation during memory subsystem testing. The traffic generator 102 may include one or more platform controller hubs (depicted as platform controller hub 0 118 and platform controller hub 1 120), which may describe a circuit that manages input/output (IO, also referred to as I/O) functions and data paths between the CPU and other system components, such as the memory. Although platform controller hubs (PCH) such as PCH0 and PCH1, do not themselves directly manage main memory (the memory controller is typically integrated into the CPU), they are part of the overall memory subsystem ecosystem by facilitating data flow between the CPU, memory, and other devices.

Various capabilities of the traffic generator to create traffic to test the memory subsystem are described in the following.

First, the traffic generator may perform bandwidth control. In this manner, the traffic generator may manage the rate at which commands are issued to the memory controller, thereby controlling the memory bandwidth. This may be achieved, for example, by using a maximal polynomial Linear Feedback Shift Register (LFSR) (for example, a 10-bit LFSR) to regulate the injection rate. The LFSR may be initialized with a multibit (for demonstrative purposes, a 10-bit value is used herein, although this is not intended to be limiting) non-zero seed value, and its injection rate may be governed by a programmable enable bit and a programmable 10-bit threshold. The LFSR may update its code every cycle, and this runtime code may then be compared with the programmed threshold to decide if a command should be injected. This may be formally understood as:
if ((enable) & (lfsr<=threshold)) then Inject

The LFSR may cycle through its code every, for example, 1023 cycles, and the threshold may determine how many times the LFSR will permit command injection within this window. For instance, setting the threshold to 1023 may allow command injection every cycle (100% rate), while setting it to 255 results in a 25% injection rate within each 1023-cycle window. When the injection rate is below 100%, periodically re-seeding the LFSR with a different code at runtime can alter the cycles during which the LFSR permits command injection. For example:
Threshold=1023: Command injection at every cycle (100% rate).
Threshold=255: Command injection at 25% rate within each 1023-cycle window.

Varying the injection rate of the LFSR allows for the measurement of a diverse set of metrics, such as latency of an unloaded memory access (idle latency) to maximum bandwidth efficiency. For example, with a low injection rate, the memory subsystem is expected to be lightly loaded or nearly idle, which would permit the measurement of minimum latency of memory accesses (e.g., idle latency) due to the fact that there would be few or no competing requests. As the injection rate increases, however, the memory subsystem may be driven toward its maximum capacity, which permits the measurement of measure peak bandwidth efficiency (e.g., how much data the system can handle per unit time under heavy load).

Moreover, by raising the injection rate from low to high, the relationship between bandwidth and latency can be plotted across all operating points, which may reveal how latency increases as the system becomes more congested. Finally, varying the injection rate may also allow the observation of how memory access patterns (e.g., hits and misses in the row buffer or cache) change under different workloads and bandwidth conditions, which may be important for understanding real-world performance and optimizing memory subsystems.

When the injection rate is below 100%, re-seeding the LFSR with different values periodically or switching between LFSRs with different polynomials helps in varying the cycles during which commands are injected, thus preventing predictable patterns and ensuring more randomness in command injection.

The base address may be is generated by a straightforward counter, such as, for example, a 32-bit counter, which may be programmed to increment in multiples of 64 bytes for each successful command injection. This counter's value may be used as the address. To pseudo-randomly alter the counter's output, a 32-bit maximal length LFSR may be employed. An enable bit may be configured to activate an exclusive OR (XOR) operation on the address bits using a mask generated by the LFSR. When this bit is set, the address bits may be XORed with the LFSR-generated code, effectively randomizing the address. Additionally, a programmable mask may permit certain address bits to be excluded from the XOR operation, further enhancing the randomization process. Reseeding LFSRs or switching between LFSRs with different maximal length polynomials at runtime may further ensure more randomness and avoids predictable patterns.

A simple way to generate read and write traffic may be to use counter-based schemes. These schemes can be configured to inject a fixed number of reads followed by a fixed number of writes. The read/write mix can be adjusted by configuring the number of reads to issue before switching to writes and vice versa. However, to achieve more random traffic, LFSRs can be used to create more unpredictable traffic patterns. Traffic can be generated using LFSRs by setting thresholds for read and write commands. When the LFSR code is within a certain range, a read or write command is generated.

For example, and to achieve different read/write mixes using a 10-bit LFSR, one may configure the LFSR to generate read and write commands based on the value of an LFSR code. The following are illustrative examples of possible combinations, but are not intended to be limiting:

50% Read/Write Mix:
Reads: When the LFSR code is at or below 511.
Writes: When the LFSR code is at or between 512 and 1023.
3:1 Read/Write Mix:
Reads: When the LFSR code is below 768.
Writes: When the LFSR code is at or between 768 and 1023, but with a
higher threshold for reads.
1:4 Read/Write Mix:
Reads: When the LFSR code is below 204.
Writes: When the LFSR code is at or between 204 and 1023.

The randomness of the traffic can be enhanced, for example, by any of using LFSRs with different polynomials, using different initial seeds for the LFSRs, or combining multiple LFSRs to generate more complex patterns.

Having an LFSR driven data pattern may be important in configuring data patterns used in writes. The LFSR codes may be used as pseudo-random data to store in DRAM. The LFSR seed and polynomial tap may be changed to add additional variability in the data, making it highly versatile for various testing scenarios.

Apart from LFSRs, additional configuration options may be available for data generation. These may include: all zeros, wherein the data pattern consists entirely of zeros; all ones, wherein the data pattern consists entirely of ones; a unique data transfer value for each nibble, wherein each nibble in a data transfer can have a unique value ranging from 0 to F; a programmable 64-bit data pattern, wherein a 64-bit programmable data pattern is used, either for a fixed nibble of all 16 transfers or for all nibbles; or a DRAM Physical Address Stored as Data Pattern, wherein the physical address of the DRAM is used as the data pattern.

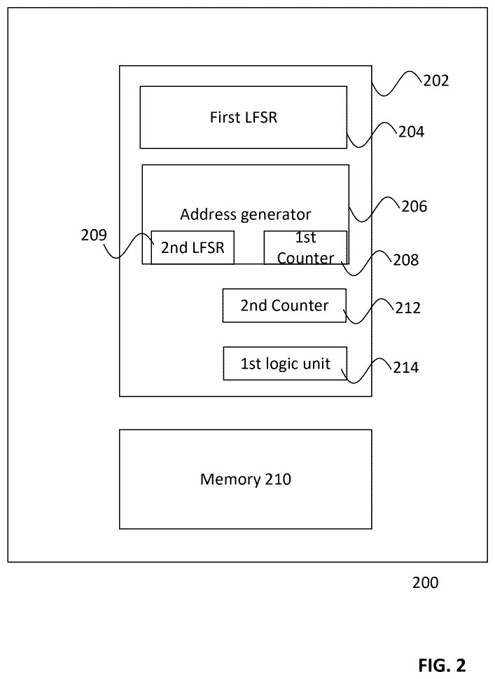

FIG. 2 depicts a device according to an embodiment. The device 200 may include an injection determiner 202, which may include a linear-feedback shift register (LFSR) 204 that is configured to generate an LFSR-output for control of a probability of sending a read command or a write command. The injection determiner 202 may be configured to compare the LFSR-output to a range of prospective LFSR-outputs. The injection determiner may be configured to send a command to read from a memory 210 or a command to write to a memory 210 if the LFSR-output is within the range. The injection determiner 202 may be configured to send no command to read from the memory 210 and no command to write to the memory 210 if the LFSR-output is outside of the range. In this manner, the injection determiner 202 may use a pseudo-random generation from the LFSR 204 to randomize when a read command or a write command is issued. Moreover, the injection determiner 202 may control a frequency or probability of the generation of a read or write command by changing the range, which in turn will result in a greater or lesser number of pseudo-random outputs falling within the range and thus resulting in the generation of a read or write command.

The LFSR 204 may be understood as a first LFSR, and the LFSR-output may be understood as a first LFSR-output. In this manner, the device 200 may further include an address generator 206, which may include a counter 208 (also referred to herein as the first counter 208), configured to generate a counter output by incrementing a value. The address generator 206 may be configured to generate a candidate memory address by performing a logic operation on the counter output and either the first LFSR-output or a second LFSR output from a second LFSR. The read command may be a command to read from the candidate memory address, and the write command is a command to write to the candidate memory address. In this manner, an address for the read command or the write command may be generated pseudo-randomly. This may result in the corresponding verification more closely mimicking real memory traffic.

The logic operation may be or include an exclusive-or (XOR) operation. In this manner, the counter-output and a pseudo-random output may be XOR'd such that they generate a memory address. A bit-mask may optionally be used to preclude the address generator from outputting a predefined bit address as a candidate memory address. In this manner, certain addresses may be precluded or protected from read or write commands.

The counter 208 may be a first counter, and the injection determiner 202 may be configured to send the read command when the first counter 208 or a second counter 212 outputs values that satisfy one or more first criteria and to send a write command when the first counter 208 or a second counter outputs values that satisfy one or more second criteria. In this manner, the first and second criteria may be any first and second criteria, without limitation. Possible options of such criteria include a counter output range, a counter output being odd or even, a counter output satisfying any set of mathematical requirements, or the like.

The injection determiner may include a first logic unit 214, configured to compare the first LFSR-output to the range; send the command to read from the memory 210 or the command to write to the memory 210 if the first LFSR-output is within the range; and send no command to read from the memory 210 and no command to write to the memory 210 if the LFSR-output is outside of the range.

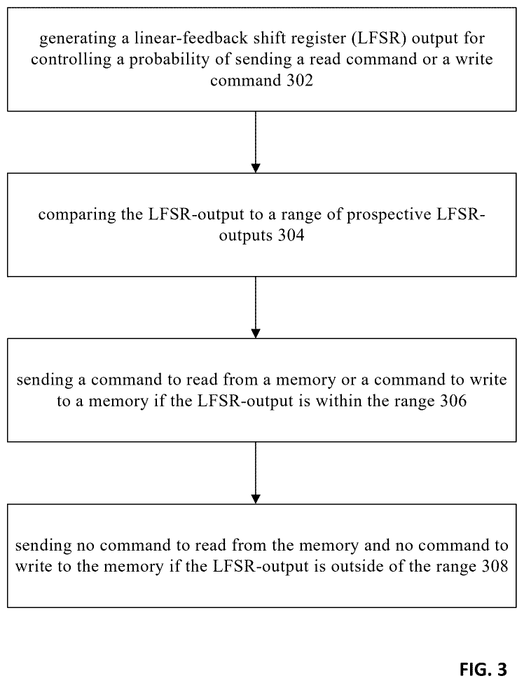

FIG. 3 depicts a method. The method includes generating a linear-feedback shift register (LFSR) output for controlling a probability of sending a read command or a write command 302; comparing the LFSR-output to a range of prospective LFSR-outputs 304; sending a command to read from a memory or a command to write to a memory if the LFSR-output is within the range 306; and sending no command to read from the memory and no command to write to the memory if the LFSR-output is outside of the range 308.

Additional aspects of the description will be disclosed by way of example:

In Example 1, a device comprising, an injection determiner, comprising: a linear-feedback shift register (LFSR), configured to generate an LFSR-output for control of a probability of sending a read command or a write command; wherein the injection determiner is configured to: compare the LFSR-output to a range of prospective LFSR-outputs; send a command to read from a memory or a command to write to a memory if the LFSR-output is within the range, and send no command to read from the memory and no command to write to the memory if the LFSR-output is outside of the range.

In Example 2, the device of claim 1, wherein the LFSR is a first LFSR, and the LFSR-output is a first LFSR-output, the device further comprising: an address generator, comprising: a counter, configured to generate a counter output by incrementing a value; wherein the address generator is configured to generate a candidate memory address by performing a logic operation on the counter output and either the first LFSR-output or a second LFSR output from a second LFSR; and wherein the read command is a command to read from the candidate memory address and the write command is a command to write to the candidate memory address.

In Example 3, the device of claim 2, further comprising the second LFSR, configured to generate the second LFSR-output.

In Example 4, the device of any one of claims 1 to 3, wherein the device is further configured to alter a probability of reading from the memory or writing to the memory by dynamically varying the range.

In Example 5, the device of any one of claims 2 to 4, wherein the logic operation comprises an exclusive-or (XOR) operation.

In Example 6, the device of claim 5, further comprising a bit-mask, configured to preclude the address generator from outputting a predefined bit address as a candidate memory address.

In Example 7, the device of any one of claims 1 to 6, wherein the counter is a first counter, and wherein the injection determiner is configured to send the read command when the first counter or a second counter outputs values that satisfy one or more first criteria and to send a write command when the first counter or a second counter outputs values that satisfy one or more second criteria.

In Example 8, the device of claim 7, wherein the value is a first value; further comprising the second counter, configured to increment a second value.

In Example 9, the device of any one of claims 1 to 9, wherein the write command comprises data to be written that was generated by the first LFSR.

In Example 10, the device of any one of claims 2 to 9, wherein the write command comprises data to be written that was generated by the second LFSR.

In Example 11, the device of any one of claims 1 to 11, wherein the injection determiner comprises a first logic unit, configured to: compare the first LFSR-output to the range; send the command to read from the memory or the command to write to the memory if the first LFSR-output is within the range, and send no command to read from the memory and no command to write to the memory if the LFSR-output is outside of the range.

In Example 12, the device of claim 12, wherein the first logic unit is a Field Programmable Gate Array or a processor.

In Example 13, the device of any one of claims 1 to 13, wherein the first LFSR is configured to generate the first LFSR-output based on a first input and a first characteristic polynomial.

In Example 14, the device of any one of claims 3 to 14, wherein the second LFSR is configured to generate the second LFSR-output based on a second input and a second characteristic polynomial.

In Example 15, a memory controller comprising the device of any one of claims 1 to 14.

In Example 16, a System on Chip, comprising the device of any one of claims 1 to 14.

In Example 17, a method of memory testing comprising, generating, using a linear-feedback shift register (LFSR), an LFSR-output for control of a probability of sending a read command or a write command; comparing the LFSR-output to a range of prospective LFSR-outputs; sending a command to read from a memory or a command to write to a memory if the LFSR-output is within the range, and sending no command to read from the memory and no command to write to the memory if the LFSR-output is outside of the range.

In Example 18, the method of claim 17, wherein the LFSR is a first LFSR, and the LFSR-output is a first LFSR-output, the method further comprising: generating a counter output by incrementing a value; generating a candidate memory address by performing a logic operation on the counter output and either the first LFSR-output or a second LFSR output from a second LFSR; and wherein the read command is a command to read from the candidate memory address and the write command is a command to write to the candidate memory address.

In Example 19, the method of claim 18, further comprising generating the second LFSR-output with the second LFSR.

In Example 20, the method of any one of claims 17 to 19, further comprising altering a probability of reading from the memory or writing to the memory by dynamically varying the range.

In Example 21, the method of any one of claims 18 to 20, wherein the logic operation comprises an exclusive-or (XOR) operation.

In Example 22, the method of claim 21, further comprising precluding the address generator from outputting a predefined bit address as a candidate memory address using a bit mask.

In Example 23, the method of any one of claims 17 to 22, wherein the counter is a first counter, further comprising sending the read command when the first counter or a second counter outputs values that satisfy one or more first criteria and sending a write command when the first counter or a second counter outputs values that satisfy one or more second criteria.

In Example 24, the method of claim 23, wherein the value is a first value; further comprising incrementing the second value with the second counter.

In Example 25, the method of any one of claims 17 to 25, wherein the write command comprises data to be written that was generated by the first LFSR.

In Example 26, the method of any one of claims 18 to 25, wherein the write command comprises data to be written that was generated by the second LFSR.

In Example 27, the method of any one of claims 17 to 27, further comprising comparing the first LFSR-output to the range; sending the command to read from the memory or the command to write to the memory if the first LFSR-output is within the range, and sending no command to read from the memory and no command to write to the memory if the LFSR-output is outside of the range.

In Example 28, the method of claim 28, wherein the first logic unit is a Field Programmable Gate Array or a processor.

In Example 29, the method of any one of claims 17 to 29, further comprising generating the first LFSR-output based on a first input and a first characteristic polynomial.

In Example 30, the method of any one of claims 19 to 30, further comprising generating the second LFSR-output based on a second input and a second characteristic polynomial.

In Example 31, a memory controller configured to perform the method of any one of claims 17 to 30.

In Example 32, a System on Chip, configured to perform the method of any one of claims 17 to 30.

In Example 33, an injection determiner, comprising: a linear-feedback shift register (LFSR), for generating an LFSR-output to control a probability of sending a read command or a write command; wherein the injection determiner is for: comparing the LFSR-output to a range of prospective LFSR-outputs; sending a command to read from a memory or a command to write to a memory if the LFSR-output is within the range, and sending no command to read from the memory and no command to write to the memory if the LFSR-output is outside of the range.

In Example 34, the injection determiner of Example 33, wherein the LFSR is a first LFSR, and the LFSR-output is a first LFSR-output, the injection determiner further comprising: an address generator, comprising: a counter, for generating a counter output by incrementing a value; wherein the address generator is for generating a candidate memory address by performing a logic operation on the counter output and either the first LFSR-output or a second LFSR output from a second LFSR; and wherein the read command is a command for reading from the candidate memory address and the write command is a command to write to the candidate memory address.

In Example 35, the injection determiner of Example 34, further comprising the second LFSR, for generating the second LFSR-output.

In Example 36, the injection determiner of any one of Examples 33 to 35, wherein the injection determiner is further for altering a probability of reading from the memory or writing to the memory by dynamically varying the range.

In Example 37, the injection determiner of any one of Examples 34 to 36, wherein the logic operation comprises an exclusive-or (XOR) operation.

In Example 38, the injection determiner of Example 37, further comprising a bit-mask, for precluding the address generator from outputting a predefined bit address as a candidate memory address.

In Example 39, the injection determiner of any one of Examples 33 to 38, wherein the counter is a first counter, and wherein the injection determiner is for sending the read command when the first counter or a second counter outputs values that satisfy one or more first criteria and for sending a write command when the first counter or a second counter outputs values that satisfy one or more second criteria.

In Example 40, the injection determiner of Example 39, wherein the value is a first value; further comprising the second counter, configured to increment a second value.

In Example 41, the injection determiner of any one of Examples 33 to 40, wherein the write command comprises data to be written that was generated by the first LFSR.

In Example 42, the injection determiner of any one of Examples 34 to 41, wherein the write command comprises data to be written that was generated by the second LFSR.

In Example 43, the injection determiner of any one of Examples 33 to 42, wherein the injection determiner comprises a first logic unit, for: comparing the first LFSR-output to the range; sending the command to read from the memory or the command to write to the memory if the first LFSR-output is within the range, and sending no command to read from the memory and no command to write to the memory if the LFSR-output is outside of the range.

In Example 44, the injection determiner of Example 43, wherein the first logic unit is a Field Programmable Gate Array or a processor.

In Example 45, the injection determiner of any one of Examples 33 to 44, wherein the first LFSR is for generating the first LFSR-output based on a first input and a first characteristic polynomial.

In Example 46, the injection determiner of any one of Examples 35 to 45, wherein the second LFSR is for generating the second LFSR-output based on a second input and a second characteristic polynomial.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A device comprising,
an injection determiner, comprising:
a linear-feedback shift register (LFSR), configured to generate an LFSR-output for controlling a probability of sending a read command or a write command;
wherein the injection determiner is configured to:
compare the LFSR-output to a range of prospective LFSR-outputs;
send a command to read from a memory or a command to write to a memory if the LFSR-output is within the range; and
send no command to read from the memory and no command to write to the memory if the LFSR-output is outside of the range.

2. The device of claim 1, wherein the LFSR is a first LFSR, and the LFSR-output is a first LFSR-output, the device further comprising:
an address generator, comprising:
a counter, configured to generate a counter output by incrementing a value;
wherein the address generator is configured to generate a candidate memory address by performing a logic operation on the counter output and either the first LFSR-output or a second LFSR output from a second LFSR; and
wherein the read command is a command to read from the candidate memory address and the write command is a command to write to the candidate memory address.

3. The device of claim 2, further comprising the second LFSR, configured to generate the second LFSR output.

4. The device of claim 1, wherein the device is further configured to alter a probability of reading from the memory or writing to the memory by dynamically varying the range.

5. The device of claim 2, wherein the logic operation comprises an exclusive-or (XOR) operation.

6. The device of claim 5, further comprising a bit-mask, configured to preclude the address generator from outputting a predefined bit address as a candidate memory address.

7. The device of claim 2, wherein the counter is a first counter, and wherein the injection determiner is configured to send the read command when the first counter or a second counter outputs values that satisfy one or more first criteria and to send a write command when the first counter or a second counter outputs values that satisfy one or more second criteria.

8. The device of claim 7, wherein the value is a first value; and further comprising the second counter, configured to increment a second value.

9. The device of claim 2, wherein the write command comprises data to be written that was generated by the first LFSR.

10. The device of claim 2, wherein the write command comprises data to be written that was generated by the second LFSR.

11. The device of claim 2, wherein the injection determiner comprises a first logic unit, configured to:
compare the first LFSR-output to the range;
send the command to read from the memory or the command to write to the memory if the first LFSR-output is within the range; and
send no command to read from the memory and no command to write to the memory if the LFSR-output is outside of the range.

12. The device of claim 11, wherein the first logic unit is a Field Programmable Gate Array or a processor.

13. The device of claim 2, wherein the first LFSR is configured to generate the first LFSR-output based on a first input and a first characteristic polynomial.

14. The device of claim 3, wherein the second LFSR is configured to generate the second LFSR output based on a second input and a second characteristic polynomial.

15. A memory controller comprising the device of claim 1.

16. A System on Chip, comprising the device of claim 1.

17. A method comprising:
generating a linear-feedback shift register output (an LFSR output) for controlling a probability of sending a read command or a write command;
comparing the LFSR output to a range of prospective LFSR-outputs;
sending a command to read from a memory or a command to write to a memory if the LFSR-output is within the range; and
sending no command to read from the memory and no command to write to the memory if the LFSR-output is outside of the range.

18. The method of claim 17, wherein the LFSR is a first LFSR, and the LFSR-output is a first LFSR-output, further comprising:
generating a counter output by incrementing a value;
generating a candidate memory address by performing a logic operation on the counter output and either the first LFSR-output or a second LFSR output from a second LFSR; and
wherein the read command is a command to read from the candidate memory address and the write command is a command to write to the candidate memory address.

19. An injection determiner, comprising:
a linear-feedback shift register (LFSR), for generating an LFSR-output to control a probability of sending a read command or a write command;
wherein the injection determiner is for:
comparing the LFSR-output to a range of prospective LFSR-outputs;
sending a command to read from a memory or a command to write to a memory if the LFSR-output is within the range; and
sending no command to read from the memory and no command to write to the memory if the LFSR-output is outside of the range.

20. The injection determiner of claim 19, wherein the LFSR is a first LFSR, and the LFSR-output is a first LFSR-output, the injection determiner further comprising:
an address generator, comprising:
a counter, for generating a counter output by incrementing a value;
wherein the address generator is for generating a candidate memory address by performing a logic operation on the counter output and either the first LFSR-output or a second LFSR output from a second LFSR; and
wherein the read command is a command for reading from the candidate memory address and the write command is a command to write to the candidate memory address.
